(19) United States
(12) Patent Application Publication
(10) Pub. No.: US 2021/0032930 A1
(43) Pub. Date: Feb. 4, 2021

(54) MANUFACTURING METHOD AND STRUCTURE OF CURTAIN LADDER STRING

(71) Applicant: A-Nan CHEN, LUKANG TOWNSHIP (TW)

(72) Inventor: A-Nan CHEN, LUKANG TOWNSHIP (TW)

(21) Appl. No.: 16/525,511

(22) Filed: Jul. 29, 2019

(51) Int. Cl. E06B 9/382; E06B 9/326

(52) U.S. Cl. CPC E06B 9/382; E06B 9/326

(57) ABSTRACT

The present invention relates to a manufacturing method and structure of curtain ladder string, the manufacturing method includes the following steps: a. weaving a ladder string body, and weaving one edge ring every certain distance along a side rope of the ladder string body; b. the edge rings on the side rope are provided to knit a mesh tube, a drawstring is provided to pass through inside the mesh tube; the curtain ladder string manufactured by the above steps is provided for assembling curtains to achieve the purpose that the drawstring does not be pulled out, to ensure safety in use and convenience of operation.

### BACKGROUND OF THE INVENTION

### Field of the Invention

The present invention relates to a manufacturing method and structure of curtain ladder string and, more particularly, to a manufacturing method and structure of a safe curtain ladder string, the curtain ladder string manufactured by the above steps is provided for assembling curtains to achieve the purpose that the drawstring does not be pulled out, to ensure safety in use and convenience of operation.

### Description of Prior Art

A conventional ladder string 1 for curtain is shown in FIG. 1, the main structure is that two side ropes 11 are respectively set on its two sides, at least one lateral support line 12 is set every certain distance between the two side ropes 11, two sides of each support line 12 are respectively connected to the two side ropes. If the conventional curtain ladder string 1 is set on a curtain, a drawstring of a curtain is exposed and it can be easily pulled out. Thus, a child may easily pull the drawstring out without any safety protection measures, if the drawstring is accidentally placed around child's neck, accident of suffocation may occur. Since this kind of accidents happens frequently, the so-called safety curtain ladders have been produced, the related technology can be referred to cited references TW M461690, TW M458177, TW M535734. There are still some drawbacks of the cited references in use or in manufacturing, for example, the drawstring may still be pulled out or the production takes time and labor supply. Take the cited reference TW M535734 as example, its structure is shown in FIG. 2, two hollow rope sleeves 13 are respectively sewn on two sides of the curtain ladder string 1, a drawstring 14 of the curtain is passed through inside each of the rope sleeve 13. The structure can prevent the drawstring 14 from being pulled out, but it cannot achieve consistent production process and fully automated production. Besides, when the curtains are folded, the rope sleeve 13 and the ladder string 1 may be in a tangle, it may spoil the beauty of curtains due to large size.

### SUMMARY OF THE INVENTION

In view of this, the inventor finally completed the manufacturing method and structure of curtain ladder string of the present invention after numerous improvements, namely, the two objects of the present invention are as follow:

One object of the present invention is to provide a manufacturing method of curtain ladder string, to achieve consistent production process and fully automated production, to thereby reduce manufacturing costs.

The other object of the present invention is to provide a curtain ladder string structure, to solve the problem that the conventional curtain ladder strings may be in a tangle, and the meshes of the hollow mesh tube of the present invention are small that children cannot put their fingers in, the drawstring does not be pulled out, to ensure safety in use and convenience of operation.

To achieve the objects of the present invention, the manufacturing method of curtain ladder string of the present invention, the steps includes:
a. weaving a ladder string body, and weaving one of the edge rings every certain distance along a side rope of the ladder string body;
b. the edge rings on the side rope are provided to knit a hollow mesh tube, a drawstring is provided to pass through inside the hollow mesh tube;

In the above step a, each of the edge rings is woven every certain distance along a side rope of the ladder string body, a lead line is further passed through the edge rings, the lead line is provided to keep the edge rings in the same direction for knitting the hollow mesh tube and the edge rings together.

The structure of the curtain ladder string of the present invention includes a ladder string body, two side ropes are respectively set on two side of the ladder string body, at least one lateral support line is set every certain distance between the two side ropes, two ends of the at least the support line are respectively connected to the two side ropes, the feature is:
one of the edge rings is woven every certain distance on the outside of each side rope, the edge rings are provided to knit two hollow mesh tubes, a drawstring is provided to pass through inside each hollow mesh tube.

Each hollow mesh tube is arranged in parallel with one of the side ropes.

The structure of the curtain ladder string of another embodiment of the present invention includes a ladder string body, two side ropes are respectively set on two side of the ladder string body, at least one lateral support line is set every certain distance between the two side ropes, two ends of the at least the support line are respectively connected to the two side ropes, the feature is:
one of the edge rings is woven every certain distance on the outside of the side ropes, two lead lines are further passed through the edge rings on each of the side ropes respectively, the edge rings are provided to knit the hollow mesh tubes, a drawstring is provided to pass through inside each of the hollow mesh tubes.

Each hollow mesh tube is arranged in parallel with one of the side ropes.

The manufacturing method of curtain ladder string of the present invention can achieve consistent production process and fully automated production, to thereby reduce manufacturing costs; the structure can solve the problem that the conventional curtain ladder strings may be in a tangle, and meshes of the hollow mesh tube of the present invention are small that children cannot put their fingers in, the drawstring does not be pulled out, to ensure safety in use and convenience of operation.

### BRIEF DESCRIPTION OF THE DRAWINGS

FIG. 1 is a schematic diagram of structure of a conventional curtain ladder string;

FIG. 2 is a schematic diagram of embodiment of a conventional curtain ladder string;

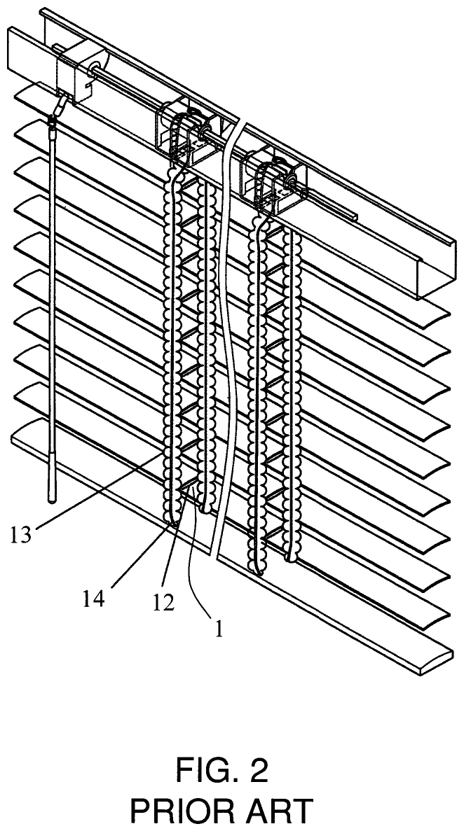

FIG. 3 is a flow chart of the manufacturing method of the present invention;

FIG. 4 is a schematic diagram of the structure of the ladder string body of the present invention;

FIG. 5 is a three-dimensional schematic diagram of the present invention;

FIG. 6 is a partial enlarged diagram of the present invention;

FIG. 7 is a schematic diagram of the structure of the ladder string body of another embodiment of the present invention;

FIG. 8 is a three-dimensional schematic diagram of another embodiment of the present invention; and

FIG. 9 is a partial enlarged diagram of another embodiment of the present invention.

### DETAILED DESCRIPTION OF THE INVENTION

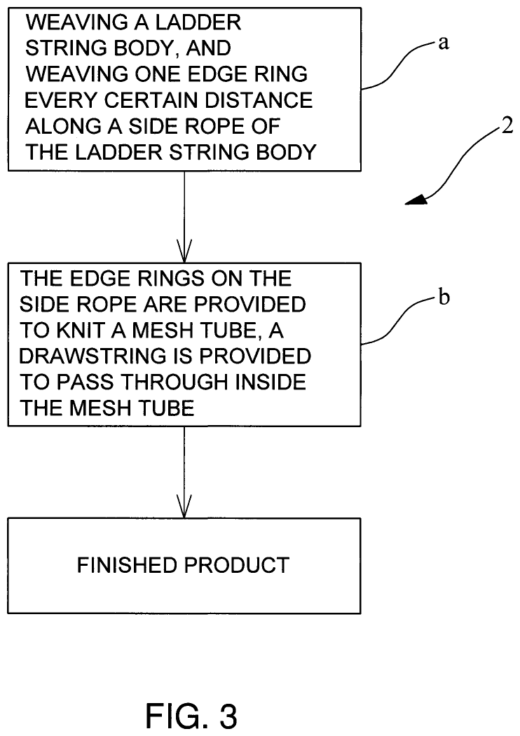

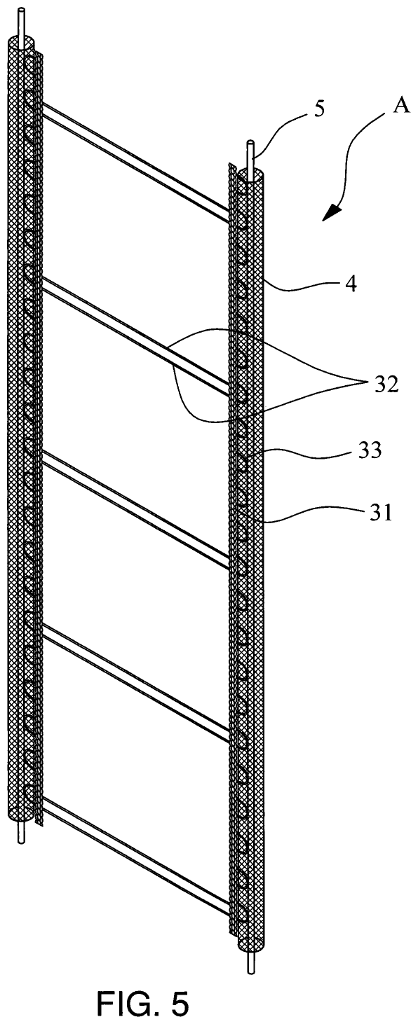

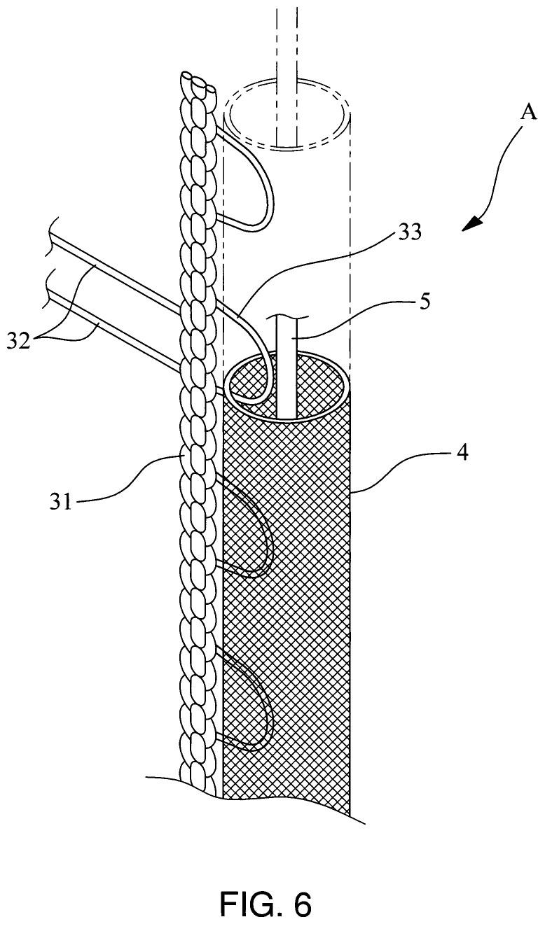

Please refer to FIG. 3 to FIG. 6, the manufacturing method 2 of the curtain ladder string of the present invention, the steps includes:
a. weaving a ladder string body 3, and weaving one of the edge rings 33 every certain distance along a side rope 31 of the ladder string body 3;
b. the edge rings 33 on the side rope 31 are provided to knit a hollow mesh tube 4, a drawstring 5 is provided to pass through inside the hollow mesh tube 4;
the curtain ladder string A manufactured by the above steps is provided for assembling curtains to achieve the purpose that the drawstring 5 does not be pulled out, to ensure safety in use and convenience of operation.

The manufacturing method 2 of curtain ladder string of the present invention is provided to achieve consistent production process and fully automated production, to thereby reduce manufacturing costs.

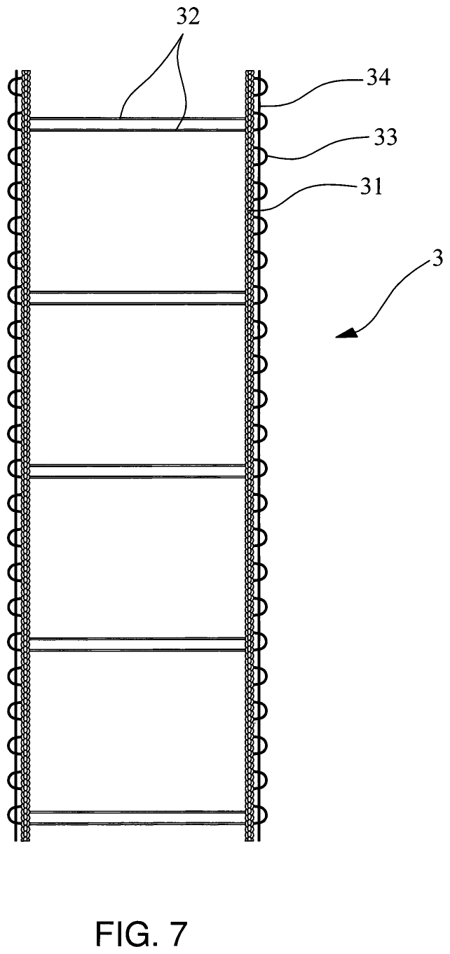

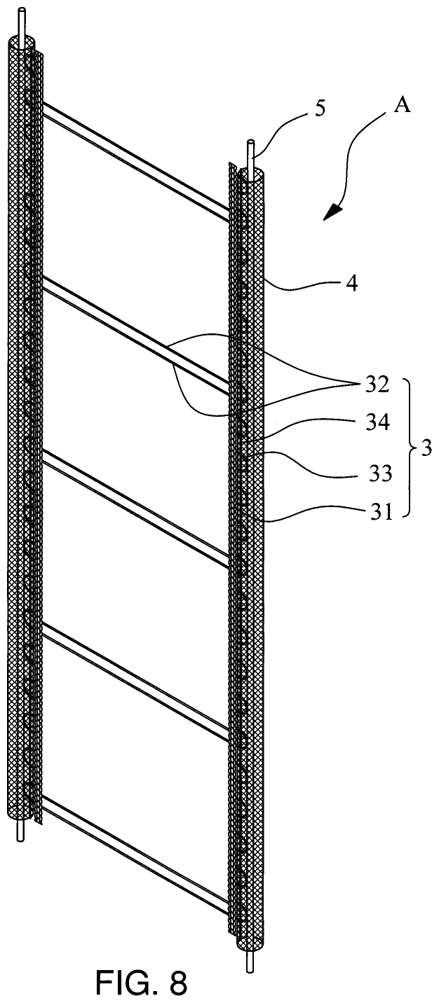

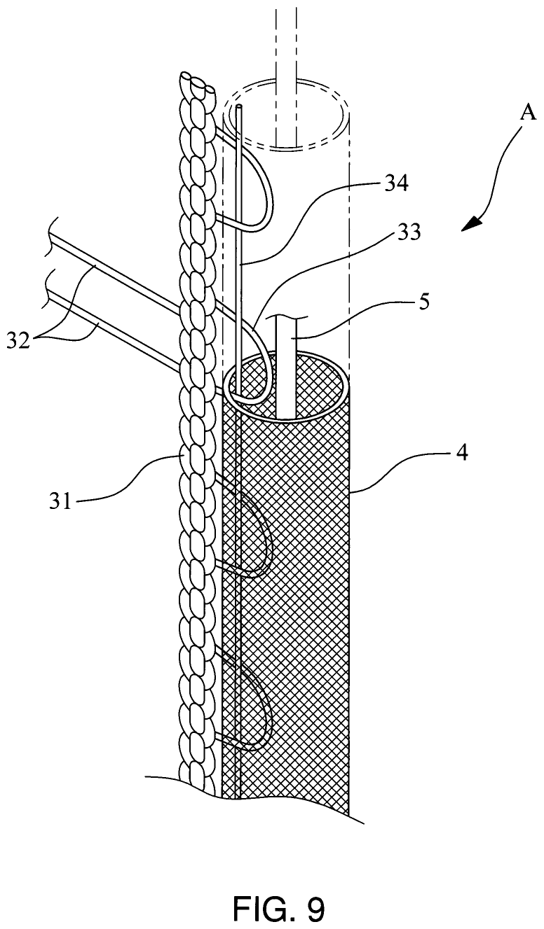

In the above step a, each of the edge rings 33 is woven every certain distance along a side rope 31 of the ladder string body 3, a lead line 34 is further passed through the edge rings 33, the lead line 34 is provided to keep the edge rings 33 in the same direction for knitting the hollow mesh tube 4 and the edge rings 33 together (please refer to the structure in FIG. 7 to FIG. 9).

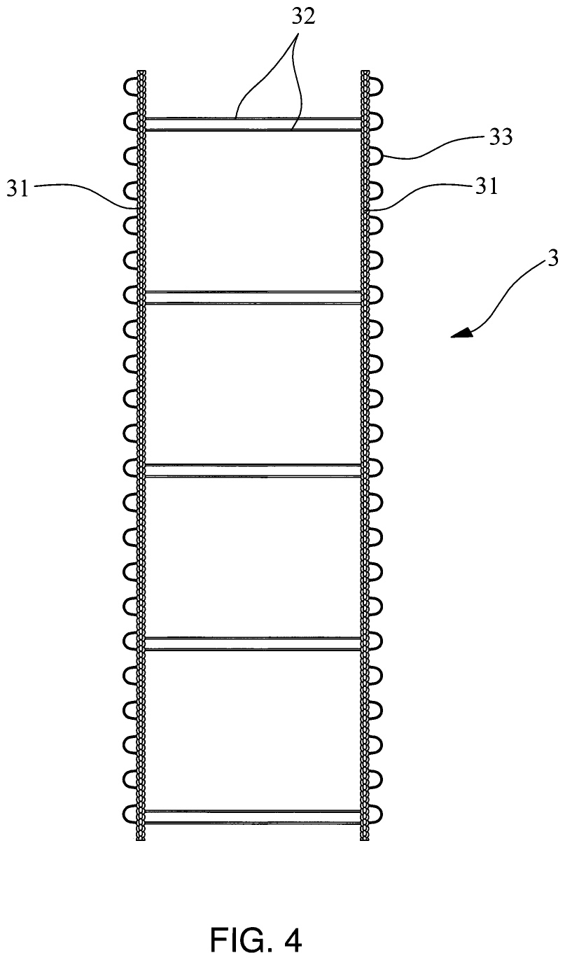

As shown in FIG. 4 to FIG. 6, the structure of the curtain ladder string A of the present invention includes:

A ladder string body 3, two side ropes 31 are respectively set on its two side, at least one lateral support line 32 is set every certain distance between the two side ropes 31, two ends of the at least the support line 32 are respectively connected to the two side ropes, the feature is:
one of the edge rings 33 is woven every certain distance on the outside of each side rope 31, the edge rings 33 are provided to knit two hollow mesh tubes 4, a drawstring 5 is provided to pass through inside each hollow mesh tube 4.

Each hollow mesh tube 4 is arranged in parallel with one of the side ropes 31.

The structure of the curtain ladder string A of another embodiment of the present invention is shown in FIG. 7 to FIG. 9, which includes:
a ladder string body 3, two side ropes 31 are respectively set on its two side, at least one lateral support line 32 is set every certain distance between the two side ropes 31, two ends of the at least the support line 32 are respectively connected to the two side ropes 31, the feature is:
one of the edge rings 33 is woven every certain distance on the outside of the side ropes 31, two lead lines 34 are further passed through the edge rings 33 on each of the side ropes 31 respectively, the edge rings 33 are provided to knit the hollow mesh tubes 4, a drawstring 5 is provided to pass through inside each of the hollow mesh tubes 4.

Each hollow mesh tube 4 is arranged in parallel with one of the side ropes 31.

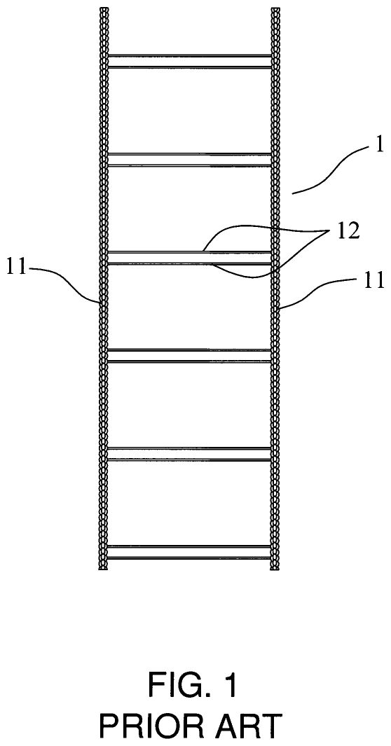

The above ladder string body 3, at least one lateral support line 32 is set every certain distance between its two side ropes 31. There are many type of ladder strings, and the ideal combination is setting two support lines 32 as a group, two support lines 32 are set every certain distance. As for the group of two support lines 32, it can be an overlapping parallel arrangement, and it also can be an up-and-down arrangement with a small interval (as shown in FIG. 1) or other arrangements. Since the structure of the support lines 32 and the side ropes 31 is the prior art, not technical features of the present invention, so it is not described here.

By the above structure, each hollow mesh tube 4 is net structure, it can be compressed to a minimum volume when the curtains are folded, so the structure would not be in a large tangle to affect the appearance of curtains. Furthermore, the hollow mesh tubes 4 are net structure, the meshes are small, so children cannot put their fingers in and the drawstrings 5 can not be pulled out, to thereby achieve safety in use and convenience of operation.

What is claimed is:

1. A manufacturing method of curtain ladder string, the steps includes:
a. weaving a ladder string body, and weaving one of the edge rings every certain distance along a side rope of the ladder string body;
b. the edge rings on the side rope are provided to knit a hollow mesh tube, a drawstring is provided to pass through inside the hollow mesh tube.

2. The manufacturing method of curtain ladder string as claimed in claim 1, wherein in the step a, each of the edge rings is woven every certain distance along the side rope of the ladder string body, a lead line is further passed through the edge rings, the lead line is provided to keep the edge rings in the same direction for knitting the hollow mesh tube and the edge rings together.

3. A structure of curtain ladder string, which includes a ladder string body, two side ropes are respectively set on two side of the ladder string body, at least one lateral support line is set every certain distance between the two side ropes, two ends of the at least the support line are respectively connected to the two side ropes, the feature is:
one of the edge rings is woven every certain distance on the outside of each side rope, the edge rings are provided to knit two hollow mesh tubes, a drawstring is provided to pass through inside each hollow mesh tube.

4. The structure of curtain ladder string as claimed in claim 3, wherein in each hollow mesh tube is arranged in parallel with one of the side ropes.

5. A structure of curtain ladder string, which includes a ladder string body, two side ropes are respectively set on two side of the ladder string body, at least one lateral support line is set every certain distance between the two side ropes, two ends of the at least the support line are respectively connected to the two side ropes, the feature is:
one of the edge rings is woven every certain distance on the outside of the side ropes, two lead lines are further passed through the edge rings on each of the side ropes respectively, the edge rings are provided to knit the hollow mesh tubes, a drawstring is provided to pass through inside each of the hollow mesh tubes.

6. The structure of curtain ladder string as claimed in claim 5, wherein in each hollow mesh tube is arranged in parallel with the side ropes.
